(19) United States
(12) Patent Application Publication
(10) Pub. No.: US 2013/0334334 A1
(43) Pub. Date: Dec. 19, 2013

(54) Chemical, System and Method for Reducing Rodent Damage in Drip Irrigation Systems

(71) Applicants: James M. Legari, Fresno, CA (US); Richard H. Clevenger, Fresno, CA (US)

(72) Inventors: James M. Legari, Fresno, CA (US); Richard H. Clevenger, Fresno, CA (US)

(21) Appl. No.: 13/527,555

(22) Filed: Jun. 19, 2012

(51) Int. Cl. B05B 15/00; A01P 17/00; A01N 31/02

(52) U.S. Cl. 239/1; 239/542; 514/706

(57) ABSTRACT

A chemical mixture and a system and method using the chemical mixture to reduce damage to the buried lines and discharge components of a subsurface drip irrigation system from rodents that may otherwise chew through these components. The chemical mixture comprises a liquid base, a surfactant, a dye and an odor producing chemical, preferably methyl mercaptan. The chemical is selected so as to produce an odor which is sufficiently intolerable to rodents to negatively disrupt their life cycle, causing rodents to exit to the surface where they are likely to be eaten by predators and to interfere with their eating and mating activities. The system and method of injecting the chemical mixture into the distribution lines of the drip irrigation system so that the mixture flows into the soil with the irrigation water. The methyl mercaptan binds with the soil, creating an odor that disrupts the life cycle of rodents.

### CROSS-REFERENCE TO RELATED APPLICATIONS

None.

### STATEMENT REGARDING FEDERALLY SPONSORED RESEARCH

Not Applicable.

### REFERENCE TO A SEQUENCE LISTING, A TABLE OR A COMPUTER PROGRAM LISTING APPENDIX SUBMITTED ON A COMPACT DISC

Not Applicable.

### BACKGROUND OF THE INVENTION

A. Field of the Invention

The field of the present invention relates generally to chemicals, systems and methods utilized to improve the operation of irrigation systems that utilize drip irrigation lines to deliver water to row crops, trees, vines and other plants. More specifically, the present invention relates to such chemicals, systems and methods that reduce the likelihood of damage to distribution lines and other drip irrigation components by gophers, moles, voles and other rodents. Even more specifically, the present invention relates to such chemicals, systems and methods that are configured to disrupt the life cycle of rodents to reduce the likelihood rodents will damage distribution lines and other buried components of subsurface drip irrigation systems.

B. Background

Irrigation systems have generally been in use for thousands of years to deliver water to trees, vines and other plants. Older systems often comprised canals, trenches, furrows and other open delivery conduits. A relatively recent improvement on irrigation systems, but which has been in use for many years, are systems known as drip irrigation systems. As well known in the relevant art, drip irrigation systems are configured to more specifically direct water to the plant or plants where water is desired. Drip irrigation systems are able to better control the use and placement of water than non-drip irrigation systems by precisely directing the water to the plants where it is needed. In addition, drip irrigation systems are much better adapted and usually specifically configured to allow for irrigation with very low flow rates. As a result, drip irrigation systems generally use somewhat less irrigation water than non-drip irrigation systems, which makes such systems particularly useful and very popular where water is expensive or generally less available, such as in the more arid regions of the world.

Drip irrigation systems connect to a source of water and distribute a controlled quantity of that water through a distribution line. The typical distribution line is a linear tape or tubing made out of polyethylene, polyvinylchloride (PVC) and like materials. In one configuration of such systems, the distribution line can be open at the distal end to deliver water to one or more plants located at the end of the distribution line, generally with a screen or like device attached to the open end of the line to keep bugs, vegetation and debris from entering the line. In another configuration, the distribution line can comprise a plurality of holes, slits or other apertures, which may be configured for somewhat controlled release of water, along the length of the tape or tubing from which water is discharged to the plants. Much more commonly, however, drip irrigation systems utilize a plurality of water flow control devices, commonly known as drip emitters, along the length of the distribution line that are arranged such that the emitters are positioned at the general locations where the plants are to be irrigated by water discharged therefrom. Typically, drip emitters are configured to discharge low or even very low flow rates from the distribution line. As is well known in the art with regard to such systems, pressurized water flows from the source of water through a distribution line towards the plants that are to be watered by that line, exiting the distribution line at the emitter in a flow controlled manner.

A drip irrigation system often includes a filter to filter the water from the source, particularly subsurface pumping, so as to reduce the likelihood that debris in the water will clog the distribution lines or, more commonly, the various apertures or drip emitters in the line. The typical drip irrigation system also has a water distribution apparatus, typically a manifold or like device, that distributes water to the plurality of distribution lines that comprise the irrigation system. The water distribution apparatus is structured and arranged to at least substantially prevent non-selective flow disparity between the distribution lines, which would otherwise result from pressure disparity between the various lines and emitters in the lines, so as to ensure the delivery of water to the plants that is reflective of that which is the most beneficial for the plants. Some drip irrigation systems have a chemical injection system, comprising a pressurized injector mechanism hydraulically connected to the distribution line, that injects chemicals such as herbicides, fungicides, algaecides, biocides and the like into the water so that the chemicals will be distributed through the various distribution lines and emitters to benefit the plants being watered by the irrigation system and/or the irrigation system itself.

Fluid distribution lines for low flow rate drip irrigation systems may be placed on top of the ground or below the surface of the ground. Although there are certain obvious advantageous with regard to the initial installation cost and maintenance of above-ground placement of the distribution lines, many modern drip irrigation systems place the distribution lines, at least those lines which are in the area of the plants, below the surface of the ground. Subsurface placement of the irrigation lines, and therefore the drip emitters associated therewith, provides a number of well known benefits. One such benefit is with regard to lower water loss due to runoff and evaporation, both of which can significantly affect water consumption levels. Subsurface drip irrigation more economically and efficiently utilizes the water by directing the water at or near the precise locations of the root systems of the plants. Another well known benefit resulting from subsurface placement of the distribution lines and emitters is that the lines and emitters are much less likely to be damaged by the tools, machinery and other equipment utilized to care for and/or harvest the plants which are being watered by the irrigation system.

One disadvantage with regard to the placement of the distribution lines below the surface of the ground in subsurface drip irrigation systems is the damage that is caused by gophers, moles, voles, mice and other rodents (hereinafter, all such damage causing varmints are collectively referred to as “rodents”). In addition to losses resulting from the rodents consuming the crop itself, rodents will burrow through a field of crops chewing on distribution lines and emitters, causing damage that can be difficult to detect, at least initially, and very expensive to repair. In fact, as is generally well known, rodents are responsible for many millions of dollars of damage to the subsurface distribution lines and emitters utilized in the agricultural and related industries. The damage caused to subsurface irrigation systems from rodents is particularly high in the growing of certain row crops, such as alfalfa, that are a well known source of food for the rodents. In fact, due to the likelihood of such damage, subsurface drip irrigation is not commonly utilized for such crops. Because rodents spend most of their time underground, primarily to avoid being eaten by owls, hawks, coyotes, wolverines and other predators, they are generally very difficult to eradicate in a field or other area that is also utilized to grow plants, such as row crops and other commercially grown plants.

Various prior art systems and methods of eradicating rodents are presently available and utilized, although with varying degrees of success. For instance, one common method of reducing rodent populations is the use of rodenticidial baits, toxicants, fumigants and the like that are specially configured and utilized to kill rodents. Rodentcidial baits are available in many forms, including pellets, oats and the like, that kill the rodents through the ingestion of the bait by the rodent. Toxicants are applied to the ground and other surfaces around an area that is infested with rodents, usually primarily in the area of the burrows or other rodent living spaces. Fumigants are typically directed into the burrows of the rodents. Major limitations with the use of rodentcidial baits, toxicants and fumigants to eradicate rodents is that these materials are highly regulated and their use with crops is very controlled. Each of these methods of eradicating rodents require an applicator and/or landowner to obtain permits specifically identifying the material to be applied and a pest control advisor to approve of the rodent control plan. In addition, these methods require significant man-hours to apply to a field and the various chemicals involved can be somewhat dangerous to handle. Unfortunately, such methods have to be reapplied on a somewhat frequent basis, the actual frequency of which is highly affected by the type of rodents and the type of crops (i.e., the rodent food source). As a result, the use of rodentcidial baits, toxicants and fumigants to eradicate rodents is difficult to apply and very expensive to use.

An alternative method of eradicating rodents is the injection of other, non-regulated substances into the burrows and tunnels of the rodents. One such substance is pressurized carbon monoxide, which can be directed into burrows and tunnels from an engine or like apparatus to suffocate the rodents. Another substance used to eradicate rodents is a mixture of propane or other flammable material and oxygen, which is typically pumped into the tunnels and then ignited to kill the rodents by concussion. Another alternative method of eradicating rodents, particularly a somewhat widespread population of rodents, is the use of owl boxes, wet soil and/or other habitat modifications. As well known, because owls kill relatively large numbers of rodents, the use of owl boxes throughout a field will, at least theoretically, attract more owls and result in less rodents. The use of wet soil will encourage rodents to leave an area due to the poor transfer of oxygen through wet soil that produces an environment which is inhospitable to the rodents. Although generally less effective due to the mobility of rodents, some growers have success with flooding portions of a field to drown the rodents. Depending on circumstances, such as the size of the field, the type of rodents and the amount of rodent infestation, some growers have successfully controlled rodents through the use of traps.

Despite the availability of numerous systems and methods of killing rodents and/or otherwise reducing rodent infestation in fields, rodents continue to be a major problem for many growers, particularly those who grow row crops such as alfalfa and the like that make certain eradication processes difficult to apply and which are known to provide a significant source of food for the rodents. In addition to damage to the crops being grown, rodents continue to be a major source of problems with regard to damaging the drip irrigation distribution lines and emitters that deliver water to the crops. What is needed, therefore, is a new and improved chemical mixture and a system and method using such chemical mixture for reducing the damaging effects of rodents in fields which utilize drip irrigation systems. Preferably, the new chemical mixture, system and method will not directly kill rodents to avoid the permitting and registration requirements, and therefore the much higher costs and various legal issues, associated with the use of rodentcidial baits, toxicants and fumigants. The new chemical mixture, system and method should be easily adaptable for use with a wide variety of different configurations of drip irrigation systems and crops grown by such irrigation systems. The new and improved chemical mixture, system and method for treating fields to reduce damage caused by rodents should utilize conventional drip irrigation components and be relatively easy and inexpensive to install.

### SUMMARY OF THE INVENTION

The chemical mixture, system and method for reducing rodent damage in drip irrigation systems of the present invention solves the problems and provides the various benefits identified above. That is to say, the present invention discloses a new and improved chemical mixture, system and method for reducing rodent damage in drip irrigation systems that disrupts the life cycle of rodents so as to reduce the likelihood that the rodents will damage the crops and/or the drip irrigation lines and emitters. The chemical mixture, system and method of the present invention utilizes a new chemical mixture and injects the mixture into the irrigation water so the chemicals are distributed throughout the distribution lines to exit the apertures or emitters in the lines to mix with the surrounding soil. The new chemical mixture, comprising methyl mercaptan and a surfactant, binds with the soil around the drip irrigation lines and produces a smell that is intolerable to rodents. The smell from the new chemical mixture disrupts the life cycle of the rodents by causing rodents to exit their tunnels and burrows, which makes them much easier prey for owls, hawks, coyotes, wolverines and other predators, and by interfering with the eating and breeding activities of the rodents. As a result, the rodent population of an area using the chemical mixture, system and method of the present invention will be reduced through increased consumption by predators and by rodents leaving the field or other area that is treated with the new chemical mixture in the new system and in accordance with the method of the present invention. Unlike presently utilized rodentcidial baits, toxicants and fumigants, the chemical mixture, system and method of the present invention do not require permits or expensive and time consuming application processes. The new chemical mixture, system and method are easily adaptable for use with a wide variety of different drip irrigation systems, particularly subsurface drip irrigation systems, and the crops grown by such irrigation systems. The chemical mixture, system and method of the present invention utilizes conventional drip irrigation components and is relatively easy and inexpensive to install.

In one general aspect of the present invention, the new chemical mixture comprises an odor producing food grade flavoring agent, such as a mercaptan-based food grade flavoring agent (e.g., methyl mercaptan), and a surfactant that are selected so as to be injected into the distribution lines of a drip irrigation system and distributed to the soil with the irrigation water and produce a smell at or near the plants and the distribution lines that is so intolerable to rodents that it will disrupt the life cycle of the rodents and reduce the likelihood of damage to the plants and drip irrigation components from rodents. The methyl mercaptan, or like odor producing chemical, negatively disrupts the life cycle of the rodents by causing the rodents to go above ground where they may be eaten by predators and by interfering with the eating and mating activities of the rodents. The surfactant is selected to facilitate delivery of the chemical mixture through the distribution lines to the plant locations and binding of the odor producing chemical with the ground at the plant locations. In one embodiment, the methyl mercaptan is utilized in a quantity that is approximately ten percent (10%) of the quantity of the surfactant. In a preferred embodiment, the chemical mixture includes a dye that is selected to indicate that one or more components of the drip irrigation system are leaking water and the chemical mixture.

In one general aspect of the system of the present invention, the system for reducing rodent damage in drip irrigation systems comprises a source of water, one or more distribution lines hydraulically connected to the source of water and configured to distribute water throughout a field or other planting area, an injector mechanism configured to inject a chemical mixture comprising an odor producing chemical, preferably methyl mercaptan, a surfactant and a dye into the distribution line so as to distribute the chemical mixture into the soil around the distribution lines. In one embodiment of the system of the present invention, the distribution lines include at least one primary distribution line and one or more, typically a plurality of, secondary distribution lines in fluid flow communication with the primary distribution line, with each of the secondary distribution lines being directed along a row of plants to discharge water and the chemical mixture into the soil near the plants. The secondary distribution lines can comprise a plurality of discharge openings through which the water and chemical mixture flow out of the secondary distribution line into the soil. In one preferred configuration of the system, the secondary distribution lines have a plurality of discharge devices, such as specially configured holes, slits or other apertures or a low flow rate emitter, associated with each of the discharge openings to controllably flow water into the soil.

In one general aspect of the method of the present invention, the method for reducing rodent damage in a drip irrigation system comprises the steps of: (a) obtaining a chemical mixture comprising a liquid base, an odor producing chemical and a surfactant; (b) injecting a quantity of the chemical mixture into one or more distribution lines of a drip irrigation system that are configured to deliver irrigation water to one or more plant locations so the chemical mixture is delivered to the plant locations; (c) discharging the chemical mixture to the ground at or near the plant locations so as to bind the odor producing chemical with the ground; and (d) producing an odor from the chemical mixture that is sufficiently offensive to rodents to negatively disrupt the life cycle of the rodents and reduce damage to the drip irrigation system. As set forth above, the odor producing chemical is specifically selected to be sufficiently intolerable to the rodents to negatively disrupt the life cycle of the rodents and the surfactant is selected so as to facilitate delivery of the chemical mixture to the plant locations and binding of the odor producing chemical with the ground at each of the plant locations. In the preferred embodiment, the odor producing chemical is methyl mercaptan and the chemical mixture includes a dye that is selected to indicate to the user that there is a leak in one or more components of the drip irrigation system.

Accordingly, the primary aspect of the present invention is to provide a new chemical mixture and an improved system and method for reducing rodent damage in drip line irrigation systems that provides the advantages discussed above and overcomes the disadvantages and limitations associated with presently available chemicals, systems and methods for reducing rodent damage in drip irrigation systems.

It is also an important aspect of the present invention to provide a new chemical mixture for reducing rodent damage in drip irrigation systems that does not utilize any regulated, controlled chemicals, such are utilized in presently available rodentcidial baits, toxicants and fumigants, so as to enable growers and others to easily and less expensively use the system and method of the present invention to reduce the likelihood of damage from rodents.

It is also an important aspect of the present invention to provide a new chemical mixture and an improved system and method of using such mixture for reducing rodent damage in drip irrigation systems that does not directly kill rodents, but instead disrupts the life cycle of the rodents so as to cause them to be more easily eaten by predators and to interfere with their eating and mating activities in a manner that reduces the population of the rodents in the field or other area in which the chemical mixture, system and method are utilized.

It is also an important aspect of the present invention to provide a chemical mixture comprising methyl mercaptan and a surfactant for use in an improved system and method of reducing damage from rodents in drip irrigation systems by producing a smell at or near the distribution lines that is so intolerable for rodents that it will disrupt the life cycle of the rodents.

It is also an important aspect of the present invention to provide an improved system for reducing rodent damage in drip irrigation systems that has an injector which injects a chemical mixture comprising methyl mercaptan and a surfactant into the distribution lines of the drip irrigation system so the chemical mixture can be discharged from the distribution line to bind with the nearby soil and produce a smell which is intolerable to rodents.

It is also an important aspect of the present invention to provide an improved method for reducing damage in drip irrigation systems that comprises the steps of injecting a chemical mixture comprising methyl mercaptan and a surfactant into the distribution lines of the drip irrigation system and discharging the chemical mixture from the distribution line into the soil to bind therewith and produce a smell which is intolerable to rodents.

It is also an important aspect of the present invention to provide a new chemical mixture and an improved system and method of using the chemical mixture for reducing rodent damage in subsurface drip irrigation systems that utilizes conventional drip irrigation components and is relatively easy and inexpensive to install.

The above and other aspects and objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a top plan view of a system for reducing rodent damage configured according to a preferred embodiment of the present invention shown in use with a typical drip irrigation system having a plurality of plant locations laid out in rows throughout a field;

FIG. 2 is a flow chart summarizing the various components of the system for reducing rodent damage of the present invention;

FIG. 3 is a flow chart summarizing a process of making a quantity of the chemical mixture of the present invention; and

FIG. 4 is a flow chart summarizing a method of reducing rodent damage configured according to one of the preferred embodiments of the present invention for use with a typical subsurface drip irrigation system.

### DETAILED DESCRIPTION OF THE PREFERRED EMBODIMENTS

With reference to the figures where like elements have been given like numerical designations to facilitate the reader's understanding of the present invention, one or more preferred embodiments of the present invention are set forth below. The enclosed text and drawings are merely illustrative of preferred embodiments and only represent several possible ways of configuring the present invention. Although specific components, materials, configurations and uses are illustrated, it should be understood that a number of variations to the components and to the configuration of those components described herein and shown in the accompanying figures can be made without changing the scope and function of the invention set forth herein. For instance, although the figures and description provided herein are primarily directed to an agricultural field having a plurality of rows of plants that are irrigated by a subsurface drip line irrigation system that is shown in use with the system and method of the present invention, those skilled in the art will readily understand that this is merely for purposes of simplifying the present disclosure and that the present invention is not so limited as the system and method of the present invention can be utilized with a variety of different types of drip line irrigation systems and plants.

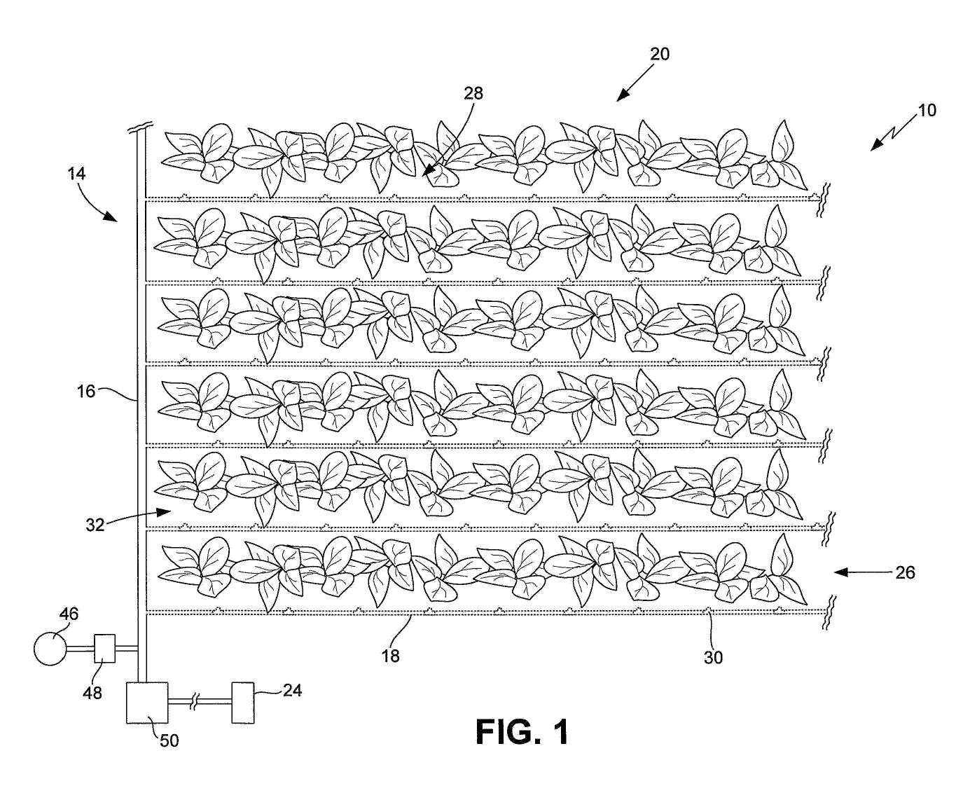

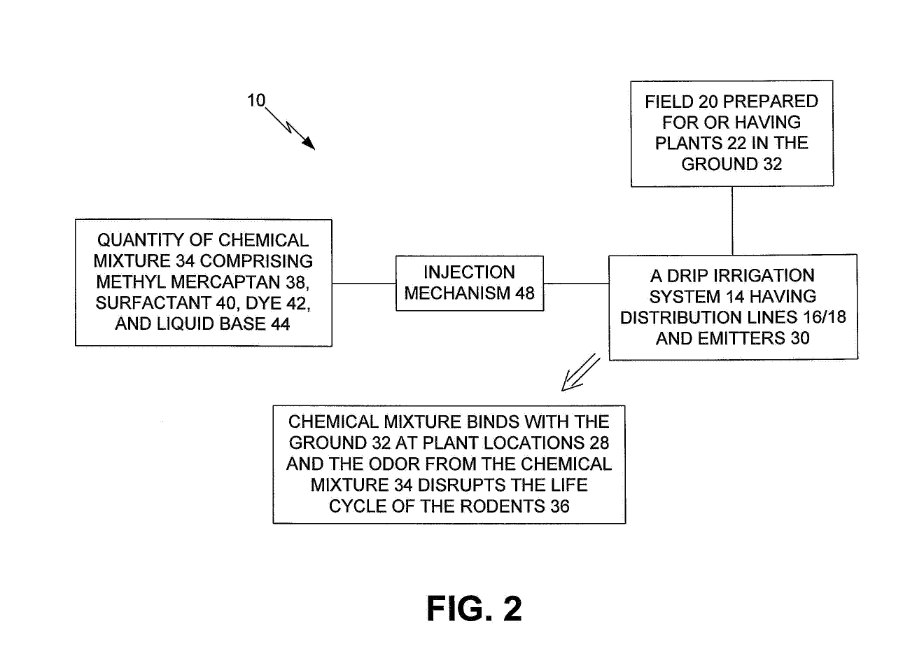

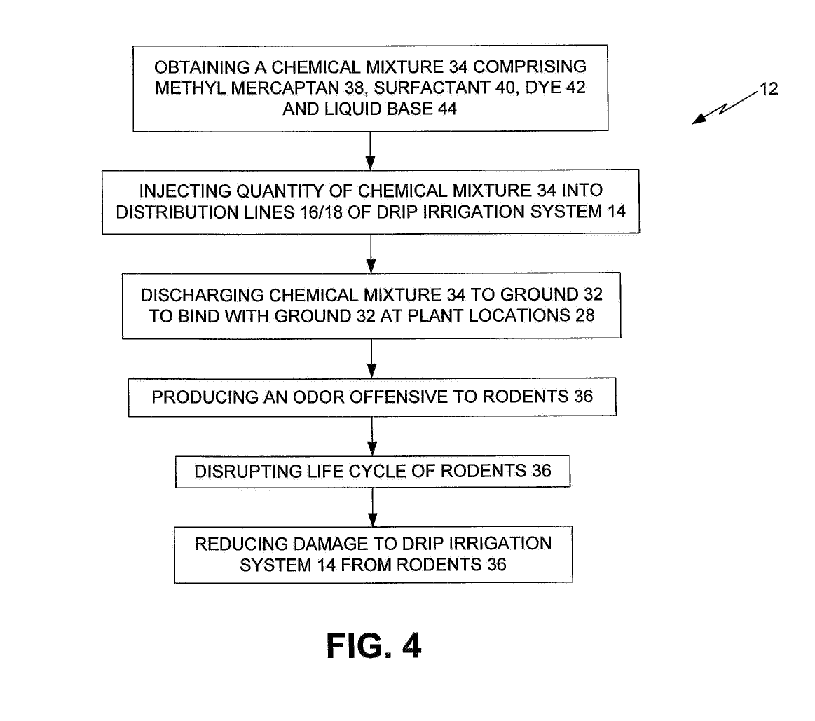

A system that comprises the components of and which is configured pursuant to a preferred embodiment of the present invention is shown generally as 10 in FIGS. 1 and 2. A preferred embodiment of the method of the present invention and which comprises the steps thereof is shown as 12 in FIG. 4. As best shown in FIG. 1, the system 10 for reducing rodent damage can be utilized with a standard drip irrigation system 14 that generally comprises one or more water distribution lines, such as the primary distribution line 16 and a plurality of secondary distribution lines 18, spread out through a field of crops or other plant growing area 20, such as an orchard, vineyard or the like, to deliver water to one or more plants 22 from a source of water 24. In FIG. 1, plants 22 are row crops, such as alfalfa or the like, that are grown in rows 26 in the field 20. Associated with each plant 22 is a plant location 28, which is where the plant 22 is or will be planted and where water will be delivered via distribution lines 16/18. In a typical drip irrigation system 14, the secondary lines 18 are placed substantially along the rows 26 of plants 22 generally adjacent one side of the row 26 of plants 22 with a discharge opening that is sized and configured to allow sufficient irrigation water to exit secondary distribution lines 18 to water the plants 22. Typically, drip irrigation system 14 has a discharge device 30, such as a specially configured hole, slit or other aperture or a low flow emitter, positioned inside, attached to or integral with the secondary lines 18 at or near each plant location 28 where a plant 22 will grow to controllably discharge water to the plants 22. Although not as common, some drip irrigation systems 14 allow the water to exit the secondary distribution line 18 to the plants 22 through an opening (as the discharge device 30) at the end of the distribution line 16/18 at or near a plant location 28, typically with a screen or other debris blocking device thereon. In the embodiment shown in FIG. 1, the drip irrigation system 14 is a subsurface system with each of the secondary distribution lines 18 buried below the surface of the ground 32.

As set forth in more detail below, system 10 of the present invention utilizes the discharge devices 30, which are collectively referred to herein as emitters, to discharge the specially treated water to the plants 22 to reduce the likelihood of damage to the buried secondary distribution lines 18 (and, as may be applicable, the primary distribution lines 16) and the emitters 30 from rodents that are burrowing through the ground 32. As well known in the art, rodents will damage the plants 22 and chew through secondary distribution lines 18 and emitters 30 as they move throughout the field 20. This can result in loss of income from damaged crops and significant expenses to repair the damage to the secondary distribution lines 18 and emitters 30. In addition to the direct crop loss and damaged components 18/30, the grower can also suffer indirect loss due to the plants 22 not receiving sufficient water as a result of cut secondary distribution lines 18. As noted in the Background above, to prevent these losses and expenses, many growers incur significant rodent eradication costs for rodentcidial baits, toxicants, fumigants, traps and other methods of killing or otherwise attempting to remove rodents from the field 20. As also noted above, many of these methods, particularly the rodentcidial baits, toxicants and fumigants, require permitting and other regulatory approval.

For purposes of describing the system 10 of the present invention, the field/planting area 20 shows six plant rows 26. As will be readily appreciated by persons skilled in the art, however, most fields 20 have a substantially larger number of plant rows 26 and utilize a plurality of primary distribution lines 16 that each have a plurality of secondary distribution lines 18 hydraulically connected thereto. Although a wide variety of materials can be utilized for the various components of drip irrigation system 14 shown in use with the system 10 of the present invention, in a preferred embodiment standard drip irrigation components are utilized. For instance, the primary distribution line 16, secondary distribution lines 18 and emitters 30 can be any of the standard and commonly utilized drip irrigation components that are utilized throughout the world. In one embodiment, the secondary distribution lines 18 are of the tape type having a discharge device 30 which is either a slit or other type of opening formed in the wall of the tape or a low flow emitter placed in the tape.

As set forth in the Background above, although subsurface drip irrigation systems 14 are prone to damage from rodents these systems have significant advantages over above-ground drip irrigation systems that cause many people to place, or desire to place, the secondary distribution lines 18 below the surface of the ground 32. None of the poisons that are presently utilized to kill rodents can be legally placed in the water that is delivered to the plants 22 through the distribution lines 16/18. As set forth in more detail below, the chemical mixture (shown as 34 in FIG. 2) of the present invention is not a poison and does not kill the rodents (shown as 36 in FIG. 2). Instead, the chemical mixture 34 discharged from secondary distribution lines 18 through the discharge devices 30 will disrupt the life cycle of the rodents 36 by causing them to exit their burrows and tunnels to the surface of the ground 32, where the rodents 36 are much more susceptible to being consumed by owls, hawks, coyotes, wolverines and other predators. In addition to making the rodents 36 more susceptible to being eaten, the chemical mixture 34 is also likely to disrupt the life cycle of the rodents 36 by interfering with their desire to eat and mate. Though not directly killing the rodents 36, the chemical mixture 34 of the present invention is likely to be much more acceptable to most growers, particularly commercial growers, due to its lower ongoing cost, ease of application, relatively low initial cost and being able to avoid the permits and other regulatory approval requirements that are necessary when using rodentcidial baits, toxicants and fumigants.

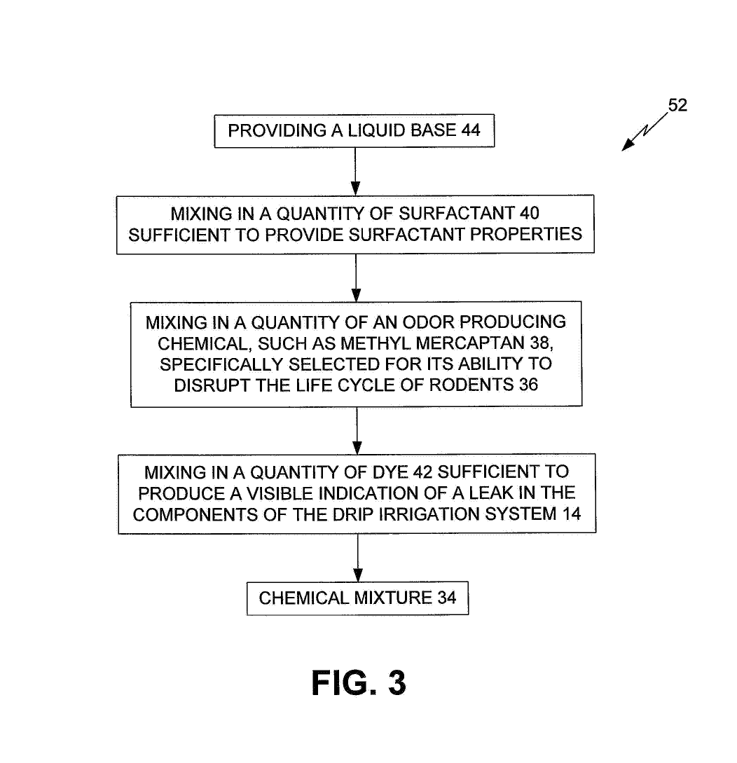

As shown in FIGS. 2 and 3, the chemical mixture 34 of the present invention comprises methyl mercaptan 38, surfactant 40 and dye 42 mixed in a liquid base 44, such as water. Although heretofore not utilized in drip irrigation systems 14 or to disrupt the life cycle of rodents 36, the composition and human effects of methyl mercaptan 38 are generally well known to persons skilled in its use. The methyl mercaptan 38 utilized with chemical mixture 34 of the present invention is a food grade material that is often utilized as a freshness component (in levels measured in the parts per billion) in many foods consumed by humans. Methyl mercaptan 38, which has a chemical name of Thiomethanol and formula of CH₄S, is either obtained from natural sources or manufactured synthetically and is readily available for purchase from a variety of sources (e.g., Advanced Biotech in Paterson, N.J.). For instance, methyl mercaptan 38 is found in various animal and plant tissue, disposed of through animal feces and occurs naturally in some nuts, cheeses and other foods. As well known in the relevant art, methyl mercaptan 38 is a colorless gas with a smell like rotten cabbage that, due to its smell, is commonly added to a variety of otherwise odorless gasses, including natural gas, so that people will be able to readily determine that there is a leak by the smell of the methyl mercaptan 38 in the gas.

The inventors of the chemical mixture 34, system 10 and method 12 of the present invention have found that the chemical mixture 34 having methyl mercaptan 38 mixed therein is effective at disrupting the life cycle of rodents 36. Specifically, the use of the methyl mercaptan 38 in chemical mixture 34 produces a strong odor that is highly intolerable to rodents 36. Due in part to the fact that rodents 36 rely so heavily on their sense of smell to locate food as they burrow their way through the ground 32, the offensive nature of the odor produced by the addition of the methyl mercaptan 38 in the chemical mixture 34 is sufficient to cause rodents 36 to leave the safety of their burrows and tunnels and exit to the surface of the ground 32. On the surface of ground 32, the rodents 36 become readily available as prey to the predators that can be found in and around most fields 20, including those such as owls which may be brought to the field 20 by the grower (i.e., by placing owl boxes throughout the field 20). In addition to making the rodents 36 easier for predators to kill, the use of the foul smelling methyl mercaptan 38 in chemical mixture 34 will disrupt the life cycle of the rodents 36 by reducing their capacity to seek out food, which destroys plants 22, and interfering with their ability to mate. In light of the odor from the chemical mixture 34, the population of rodents 36 in a field that is treated with the chemical mixture 34 will be reduced by rodents 36 being eaten by predators, leaving the area because of the odor and failing to breed.

In one embodiment, a quantity of the chemical mixture 34 is made by mixing four ounces of methyl mercaptan 38 and forty ounces of surfactant 40 in thirty gallons of base liquid 44, as set forth in the chart in FIG. 3. In a preferred embodiment, a sufficient amount of dye 42 is included to “mark” the chemical mixture 34 in case there is a leak in one of the distribution lines 16/18, an emitter 30 or other components of the system 10. As may be readily appreciated by persons skilled in the art of handling this type of chemical, the methyl mercaptan 38 needs to be handled in a manner that keeps it stable for purposes of mixing it with the surfactant 40 and base liquid 44. In general, the methyl mercaptan 38 should be kept as close to 32° F. as possible during the preparation process to prevent it from becoming an unstable, flammable gas. The surfactant 40 for the chemical mixture 34 should be chosen for its ability to mix well with the methyl mercaptan 38 and provide the desired surfactant properties, including facilitating delivery of the chemical mixture 34 to the plant locations 28 and binding of the odor producing chemical methyl mercaptan 38 with the ground 32 at the plant locations 28. In one embodiment, the inventors have found that the surfactant Deploy™ (a trademark of Monsanto Corporation) works well for chemical mixture 34. A wide variety of different dyes 42 of different types and colors can be utilized with chemical mixture 34.

In one of the preferred applications of chemical mixture 34, the system 10 includes a storage tank 46 that stores a quantity of chemical mixture 34, preferably located in the field 20 near the surface components of the drip irrigation system 14, as shown in FIG. 1. An injector mechanism 48, such as a pressurized injector (the structure and use thereof are well known to those skilled in the art) or the like is hydraulically connected to the drip irrigation system 14 to inject the chemical mixture 34 into the water flowing through the distribution lines 16/18 so that the chemical mixture 34 will be delivered to the plant locations 28 in the field 20 with the irrigation water that is used to water the plants 22. Typically, a filter apparatus 50 will be provided to filter the water from the source of water 24, particularly if the source of water 24 is a subsurface pump or the like. In another embodiment, the storage tank 46 is not utilized. Instead, a truck or other delivery system delivers the desired quantity of chemical mixture 34 to the injector mechanism 48 for direct injection into the drip irrigation system 14 as and when needed to treat the field 20 to reduce the likelihood of damage from rodents 36. Typically, the chemical injector 48 will be in fluid flow communication with the primary distribution line 16 so that the chemical mixture 34 will be delivered with the irrigation water to each of the secondary distribution lines 18 and, from these lines 18, to the ground 32 around the plant locations 28. Chemical mixture 34 will exit the secondary distribution lines 18 through the discharge devices 30, whether they are holes, slits or other apertures in the secondary distribution lines 18 or emitters, such as low flow emitters, in the lines 18. The methyl mercaptan 38 in chemical mixture 34 will bind with the ground/soil 32 at or near the plant locations 28 and produce the odor therefrom that is so intolerable to the rodents 36 that it will disrupt their life cycle, as described herein. In a preferred use of the system 10 and method 12 of the present invention, chemical mixture 34 will be applied on a routine or regular basis as part of a maintenance program to drive rodents 36 away and keep rodents 36 from returning to the field 20. Because the methyl mercaptan 38 disrupts the life cycle of the rodents 36, it will keep them from chewing on distribution lines 16/18, discharge devices 30 and other components of the drip irrigation system 14 and drive the rodents 36 from the ground 32, which causes a reduction in the number of rodents 36 through predator action and interference with their breeding.

A method of making the chemical mixture 34 of the present invention is shown as 52 in FIG. 3. The method 52 comprises the steps of (a) providing a quantity of liquid base 44, such as thirty gallons of water; (b) mixing in a quantity of surfactant 40 sufficient for the surfactant 40 to provide its desired properties, such as forty ounces of Deploy™; (c) mixing in a quantity of an odor producing chemical, such as methyl mercaptan 38, that is specifically selected for its ability to disrupt the life cycle of rodents 36 in sufficient quantity to produce the desired odor, such as in a ratio of ten percent (10%), or four ounces, of the surfactant 40; and (d) mixing in a quantity of dye 42 sufficient to produce a visible indication of a leak in the distribution lines 16/18 and/or other components of the drip irrigation system 14. As will be readily appreciated by those skilled in the art, the exact quantity of the liquid base 44, surfactant 40, odor producing chemical 38 and dye 42 will depend on the materials selected and the amounts thereof necessary to achieve the desired affect on the life cycle of the rodents 36 in a particular field 20 of plants 22. In addition, as also will be readily appreciated by those skilled in the art, the order of mixing the components of the chemical mixture 34 summarized above and set forth in FIG. 3 is provided for exemplary purposes only, as the order of the mixing steps can be modified, combined or otherwise altered and still provide the desired chemical mixture 34.

A method 12 of utilizing chemical mixture 34 to reduce the likelihood of damage from rodents 36 in a drip irrigation system 14 is summarized in FIG. 4. In this method 12, the user obtains a quantity of chemical mixture 34 sufficient to treat the entire drip irrigation system 14 in a manner that reduces damage from rodents 36 throughout the field 20. The chemical mixture 34 is mixed into the water used by the drip irrigation system 14, typically by injection into one or more of the distribution lines 16/18 thereof using an injector mechanism 48 positioned downstream of the filter apparatus 50 that filters the water from the source of water 24. In an alternative embodiment, the chemical mixture 34 is injected into the irrigation water using a non-pressurized mixing tank or the like that receives water from the source of water 24 and allows the user to combine the chemical mixture 34 with the water. The chemical mixture 34 will flow with the irrigation water through distribution lines 16/18 and then be discharged to the ground 32 at or near each of the plant locations 28 through the discharge devices 30, such as low flow emitters and the like. The chemical mixture 34 will move along the tape or tube of the secondary distribution line 18 and the odor producing chemical, such as the methyl mercaptan 38, will bind with the ground/soil 32 at or near the plant locations 28. The methyl mercaptan 38, or an equivalent odor producing chemical, will produce an odor that is offensive and generally intolerable to the rodents 36. Due to their strong sense of smell, the rodents 36 will be able to smell the odor as they move through their tunnels in areas of the field 20 that are not at or near the plant locations 28. The odor from the methyl mercaptan 38 or the like will disrupt the life cycle of the rodents 36, such as causing them to exit the safety of their below ground locations to the surface where they are more likely to be eaten by a predator and/or interfere with their eating and mating activities. Whether through being eaten, less breeding or being driven from field 20, chemical mixture 34 will result in much less rodent damage to the plants 22 and the various components of the drip irrigation system 14.

In one embodiment, the inventors have found that approximately one gallon of the chemical mixture 34 per acre to be treated is sufficient to provide the desired rodent damage reducing effect. As will be readily appreciated by those skilled in the art, the volume of chemical mixture 34 necessary for a particular drip irrigation system 14 will depend on various factors, including the type of plants 22 being grown in the field 20 and irrigated by the drip irrigation system 14, the type of ground/soil 32 at the plant locations 28, the depth the distribution lines 18 are buried, the spacing of the emitters or other discharge devices 30 and the type and initial infestation of rodents 36. For instance, certain types of row crops, such as alfalfa and the like, provide very abundant quantities of food source for rodents 36. As such, the fields 20 in which these types of plants 22 are grown are likely to require higher concentrations of chemical mixture 34 than fields 20 that grow plants 22 which are less desirable to rodents 36. Other factors may also be important for the quantity of chemical mixture 34 necessary to achieve the desired results. With regard to the need for re-application of the treatment to a field 20 by the chemical mixture 34, various factors will affect the decision on the timing for such re-application. In addition to the factors set forth above for the volume per acre analysis, particularly the food source factor of plants 22, another factor that will affect the decision to re-apply chemical mixture 34 is the likelihood that rodents 36 will return to the field 20 from other nearby areas. For instance, fields 20 growing plants 22 that are highly desirable to rodents 36 as a source of food are likely to require more often re-application of chemical mixture 34 than those fields 20 having plants 22 that are less desirable as food sources to the rodents 36. Another factor is the ability of the ground/soil 32 at or near the plant locations 28 to “hold” the odor producing chemical 38 (i.e., they ethyl mercaptan) so as to continue producing the desired rodent-offensive odor.

As set forth above, the present invention discloses a new chemical mixture 34, system 10 and method 12 for use in drip irrigation systems 14 that disrupts the life cycle of the rodents 36 in a manner that reduces the likelihood the rodents 36 will damage the plants 22 and/or the buried drip irrigation lines 18 and emitters or other discharge devices 30. The chemical mixture 34, system 10 and method 12 of the present invention utilize methyl mercaptan 38 to produce an odor in the ground 32 of the field 20 in which the chemical mixture 34 is used that rodents 36 find highly intolerable. Other odor producing chemicals which are able to produce the same negative life cycle impact for rodents 36 may also be able to be utilized for chemical mixture 34. The chemical mixture 34 is injected into the irrigation water so the chemical mixture 34 is distributed throughout the distribution lines 16/18 to exit the apertures, emitters or other discharge devices 30 in the buried distribution lines 18 to mix with the surrounding ground 32. The chemical mixture 38, which comprises the methyl mercaptan 38 and a surfactant 40, binds with the ground 32 around the buried drip irrigation lines 18 and produces an odor that is intolerable to rodents 36. The smell from the chemical mixture 34 disrupts the life cycle of the rodents 36, causing the rodents 36 to exit their tunnels and burrows, which makes them much easier prey for owls, hawks, coyotes, wolverines and other predators, and by interfering with the eating and breeding activities of the rodents 36. As a result, the rodent population of a field 20 or other area using chemical mixture 38, system 10 and method 12 of the present invention will be reduced through increased consumption by predators and by rodents 36 leaving the field 20 or other area that is treated with chemical mixture 34 using the new system 10 and in accordance with the method 12 of the present invention. Unlike presently utilized rodentcidial baits, toxicants and fumigants, chemical mixture 34, system 10 and method 12 of the present invention do not require permits or expensive and time consuming application processes. As will be readily appreciated by those skilled in the art, the chemical mixture 34, system 10 and method 12 are easily adaptable for use with a wide variety of different drip irrigation systems 14 and the plants 22 (e.g., crops) grown with such irrigation systems 14.

While there are shown and described herein one or more specific forms of the invention, it will be readily apparent to those skilled in the art that the invention is not so limited, but is susceptible to various modifications and rearrangements in design and materials without departing from the spirit and scope of the invention. In particular, it should be noted that the present invention is subject to modification with regard to any dimensional relationships set forth herein and modifications in assembly, materials, size, shape, and use. For instance, there are numerous components described herein that can be replaced with equivalent functioning components to accomplish the objectives of the present invention.

What is claimed is:

1. A chemical mixture for reducing damage from rodents in a field having a drip irrigation system configured to deliver water to one or more plants at a plurality of plant locations, said chemical mixture comprising:
a liquid base;
an odor producing chemical mixed in said liquid base, said odor producing chemical specifically selected so as to be sufficiently intolerable to the rodents to negatively disrupt the life cycle of the rodents; and
a surfactant mixed in said liquid base with said odor producing chemical, said surfactant selected so as to facilitate delivery of said chemical mixture to said plant locations and binding of said odor producing chemical with the ground at said plant locations.

2. The chemical mixture of claim 1, wherein said odor producing chemical is methyl mercaptan.

3. The chemical mixture of claim 2, wherein the quantity of said methyl mercaptan is approximately 10% of the quantity of said surfactant.

4. The chemical mixture of claim 3 further comprising a dye mixed in said liquid base with said methyl mercaptan and said surfactant, said dye selected so as to indicate leaking in said drip irrigation system.

5. The chemical mixture of claim 1 further comprising a dye mixed in said liquid base with said odor producing chemical and said surfactant, said dye selected so as to indicate leaking in said drip irrigation system.

6. A system for reducing damage from rodents in a field having one or more plants at a plurality of plant locations, said system comprising:
a drip irrigation system having one or more distribution lines that are hydraulically connected to a source of water to distribute water from said source of water to said plant locations;
a chemical mixture comprising an odor producing chemical and a surfactant mixed in a liquid base, said odor producing chemical specifically selected so as to be sufficiently intolerable to the rodents to negatively disrupt the life cycle of the rodents, said surfactant selected so as to facilitate delivery of said chemical mixture to said plant locations and binding of said odor producing chemical with the ground at said plant locations; and
means for injecting said chemical mixture into at least one of said one or more distribution lines so as to deliver said chemical mixture to said plant locations.

7. The system of claim 6, wherein said odor producing chemical is methyl mercaptan.

8. The system of claim 7, wherein the quantity of said methyl mercaptan in said chemical mixture is approximately 10% of the quantity of said surfactant therein.

9. The system of claim 8 further comprising a dye mixed in said liquid base with said methyl mercaptan and said surfactant, said dye selected so as to indicate leaking in said drip irrigation system.

10. The system of claim 9, wherein said one or more distribution lines comprises a primary distribution line and a plurality of secondary distribution lines, said secondary distribution lines buried beneath the surface of the ground, said injecting means configured to inject said chemical mixture into said primary distribution line.

11. The system of claim 10, wherein said injecting means is a pressurized injector.

12. The system of claim 6 further comprising a dye mixed in said liquid base with said odor producing chemical and said surfactant, said dye selected so as to indicate leaking in said drip irrigation system.

13. The system of claim 6, wherein said one or more distribution lines comprises a primary distribution line and a plurality of secondary distribution lines, said secondary distribution lines buried beneath the surface of the ground.

14. The system of claim 13, wherein said injecting means is configured to inject said chemical mixture into said primary distribution line.

15. The system of claim 14, wherein said injecting means comprises a pressurized injector.

16. A method for reducing damage from rodents in a field having one or more plants at each of a plurality of plant locations and a drip irrigation system associated with the field to deliver water from a source of water to the plant locations, said method comprising the steps of:
a) obtaining a chemical mixture having a liquid base, an odor producing chemical and a surfactant, said odor producing chemical specifically selected so as to be sufficiently intolerable to the rodents to negatively disrupt the life cycle of the rodents, said surfactant selected so as to facilitate delivery of said chemical mixture to said plant locations and binding of said odor producing chemical with the ground at said plant locations;
b) injecting a quantity of said chemical mixture into one or more distribution lines of the drip irrigation system, said one or more distribution lines hydraulically interconnecting the source of water and said plant locations so as to deliver said chemical mixture to said plant locations;
c) discharging said chemical mixture to the ground at or near said plant locations so as to bind said odor producing chemical with the ground; and
d) producing an odor from said chemical mixture that is sufficiently offensive to the rodents to negatively disrupt the life cycle of the rodents and reduce damage to said drip irrigation system.

17. The method of claim 16, wherein said odor producing chemical is methyl mercaptan.

18. The method of claim 17, wherein the quantity of said methyl mercaptan in said chemical mixture is approximately 10% of the quantity of said surfactant therein.

19. The method of claim 18 further comprising a dye mixed in said liquid base with said methyl mercaptan and said surfactant, said dye selected so as to indicate leaking in said drip irrigation system.

20. The system of claim 16 further comprising a dye mixed in said liquid base with said odor producing chemical and said surfactant, said dye selected so as to indicate leaking in said drip irrigation system.
